(19) United States
(12) Patent Application Publication
(10) Pub. No.: US 2007/0290067 A1
(43) Pub. Date: Dec. 20, 2007

(54) Individually controlled sprinkler and lighting system

(76) Inventor: Sergio Espinoza, Fullerton, CA (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/455,967

(22) Filed: Jun. 20, 2006

(51) Int. Cl. A01G 27/00

(52) U.S. Cl. 239/69

(57) ABSTRACT

An individually controlled sprinkler system includes a water source providing water at a suitable pressure for a sprinkler system. A piping system including at least two sprinkler heads is connected to the water source at locations remote from the water source. Each of the sprinkler heads has an electrically controllable valving system. A microprocessor control system is electrically connected to each of the sprinkler heads. The control system is programmable and provides controllable input signals to the sprinkler heads allowing an individually adjusted flow to be produced by each sprinkler head. The control system also provides programmed input signals to lighting fixtures. The sprinkler heads and lighting fixtures are connected to the control system with wires or using a radio frequency transmitter connected to the control system and suitable receivers connected to the sprinkler heads and lighting fixtures. The control system is accessed remotely over a network or telephone system.

### FIELD OF THE INVENTION

The invention pertains to sprinkler and lighting systems. More particularly, the invention relates to lawn and garden systems in which individual sprinkler heads and lighting fixtures are remotely controlled.

### BACKGROUND OF THE INVENTION

Automated sprinkler systems for laws and gardens and related automated lighting systems have existed for many years. These systems tend to be arranged with a number of branches or circuits, each of which includes several sprinkler heads or several lighting fixtures. These branches or circuits are typically controlled by an automated timer that serves to turn on and off the control valves or switches for each circuit. As a result, every sprinkler heas on a given branch or circuit will be turned on at the same time and for the same duration. The same is true for lighting fixtures controlled in this fashion. Depending on sunlight exposure, shade and ground cover, the water delivered by individual sprinkler heads controlled in this way might be inappropriate for the particular location of the sprinkler head. Some areas may require more water or less, depending upon individual conditions.

Various designs for sprinkler and lighting control systems have been developed inventors. U.S. Pat. No. 5,262,936, issued to Faris et al., discloses an irrigation controller that contains a base unit having drivers and output switches for controlling a number of irrigation stations which is less than the maximum number of stations for which the controller is designed. Station expansion modules are provided having the drivers and output switches for incremental numbers of stations. The station expansion modules can be individually bought and connected to the base unit to expand the number of available irrigation stations up to the maximum number of stations. A microprocessor in the base unit can be programmed and controls all of the stations, both those in the base unit and those in the station expansion modules. Pump and accessory timer modules can also be provided for optionally driving a pump and/or an accessory device such as a lighting system.

U.S. Pat. No. 6,782,310, issued to Bailey et al. is directed to a wireless irrigation system that has a controller that is self-contained and located at a central site. The controller communicates through a commercial communication network such as a pager network to a plurality of irrigation control devices. Based on watering schedules stored in the memory, signals are sent to irrigation device controllers to start and stop pumps or valves. The remote wireless controllers have batteries for operation that are charged by power generators that may be a solar array.

U.S. Patent Application No. 2005/0171646, published by Miller illustrates a An irrigation controller for selectively turning on and off a set of sprinkler valve stations. The irrigation controller is programmable by a user. The irrigation controller includes an irrigation control processor. The irrigation control processor includes an input port, an output port, a memory element for storing an irrigation control program and irrigation control parameters, the irrigation control program implementing a plurality of functionalities that are selectively enabled, a processing unit for executing the irrigation control program, and a bus connecting said processing unit to said memory element and to said input and output ports. An input device is interfaced with the input port. The output port is provided with interface with the sprinkler valve stations for controlling the turning on and off of the sprinkler valve stations. The input device cooperates with the control program to enable at least one specific functionality from the functionalities in response to a predetermined input being received from the user through the input device.

U.S. Patent Application No. 2005/0267605, published by Lee et al. disclose a system and method of home entertainment, security, surveillance, and automation control includes a plurality of remote devices, a display device, and various user input devices capable of receiving a home user's commands. The system further includes a main control unit capable of controlling and programming the system, and a communication link capable of transferring various data and control signals between the main unit and the plurality of remote devices. The home user's command enables to select the remote devices, to transmit various automation control signals, and to establish exchanges of various data between the main control unit and at least one of the plurality of remote devices. Finally, the communication link between the main control unit and the remote devices includes power line communication network over existing home AC power line. The home user is also able to control and communicate with the system at remote location over the Internet.

U.S. Patent Application No. 2005/0267641, published by Nickerson et al. is directed to a modular and expandable irrigation controller that provides flexible and expandable capabilities for controlling an irrigation system having a plurality of removable modules capable of performing a variety of functions. The controller in many embodiments is user-programmable in any one of a plurality of languages. The versatility of the system can be expanded by using a variety of special modules including expansion modules, input modules for receiving signals from a plurality of sensors, data modules, individual transmitter modules (for signaling self-powered valves), alarm modules (fault condition), lighting modules, communication modules (internet or other transmission systems), decoder modules (transmit to a plurality of devices on a single twisted pair) and a remote control module (remote controller control).

U.S. Patent Application No. 2002/0002425, issued to Dossey et al. discloses an adaptable controller for controlling environmental systems, and more particularly an improved computer-controlled irrigation and lighting system. Scheduling is selected using a unique graphical user interface and is transmitted to the controller remotely. Sensing devices for water flow to determine leaks and calculate usage using venturi are provided which communicate with the controller to adjust output in real time based on the measurements. U.S. Pat. No. 6,731,992, issued to Ziegler, Jr. discloses an advanced remotely accessible energy control system utilizes a client/server software architecture, and an “open” communication protocol, such as the well known TCP/IP protocol for design-in remote accessibility. Multiple graphic user interface clients can operate on widely available computers incorporating operating systems which are well suited to graphic user interface functions, while the energy control server and the input/output interface components can operate on a separate computer, using other or different operating systems, which are adapted to the processing performed there. According to the invention, the graphic user interface software is resident on one or more graphic user interface consoles or clients, so that processing for formatting data for display, and processing of input actions taken by a system user are offloaded from the server to the graphic user interface clients. Data describing the format of the display is stored on the server, so a user can move the graphic user interface software to another computer, connect to the server and view the system information, without transporting files describing the format of the display.

It is an objective of the present invention to provide a sprinkler and lighting control system that permits control of individual sprinkler heads and lighting fixtures. It is a further objective to provide a system that provides the desired control through either a wired or wireless system. Finally, it is an objective of the present invention to provide such a system that is durable, reliable and easily and inexpensively manufactured.

While some of the objectives of the present invention are disclosed in the prior art, none of the inventions found include all of the requirements identified.

### SUMMARY OF THE INVENTION

The present invention addresses all of the deficiencies of prior art sprinkler and lighting system inventions and satisfies all of the objectives described above.

(1) An individually controlled sprinkler and lighting system providing the desired features may be constructed from the following components. A water source is provided. The water source provides water at a suitable pressure for a sprinkler system. A piping system is provided. The piping system is connected to the water source. At least two sprinkler heads are provided. The sprinkler heads are connected to the piping system at locations remote from the water source. Each of the sprinkler heads has an electrically controllable valving system. A microprocessor control system is provided. The control system is electrically connected to each of the sprinkler heads. The control system is programmable and provides controllable input signals to the sprinkler heads. When the control system sends programmed control input signals to the sprinkler heads, an individually adjusted flow will be produced by each sprinkler head.

(2) In a variant of the invention, at least two lighting fixtures are provided. The lighting fixtures are located adjacent the sprinkler heads. The lighting fixtures are electrically connected to the microprocessor control system. When the control system sends programmed control input signals to the lighting fixtures, the fixtures are individually controlled.

(3) In another variant, the system includes an input device connected to the microprocessor control system.

(4) In still another variant, the system includes a display screen connected to the microprocessor control system.

(5) In yet another variant, radio frequency controlled valving devices are connected to each of the sprinkler heads and a radio frequency signal generator is connected to the microprocessor control system, thereby providing wireless control of the sprinkler heads.

(6) In a further variant, the system includes radio frequency controlled input devices. The input devices are electrically connected to the lighting fixtures and a radio frequency signal generator is connected to the microprocessor control system, thereby providing wireless control of the lighting fixtures.

(7) In still a further variant, the microprocessor control system is connected to a network. The network is remotely accessed for programming and control of the control system.

(8) In yet a further variant, the microprocessor control system is remotely accessed through a telephone network.

(9) In another variant of the invention, the microprocessor control system is remotely accessed through a text-messaging system.

(10) In a final variant, the microprocessor control system is remotely accessed through a voice recognition system.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic view of a first embodiment of the invention;

FIG. 2 is a schematic view of the FIG. 1 embodiment with lighting fixtures added;

FIG. 3 is a schematic view of the FIG. 1 embodiment with radio frequency transmitter and receivers for controlling the sprinkler heads and lighting fixtures; and

FIG. 4 is a schematic view of the control system and means for accessing same.

### DETAILED DESCRIPTION OF THE PREFERRED EMBODIMENTS

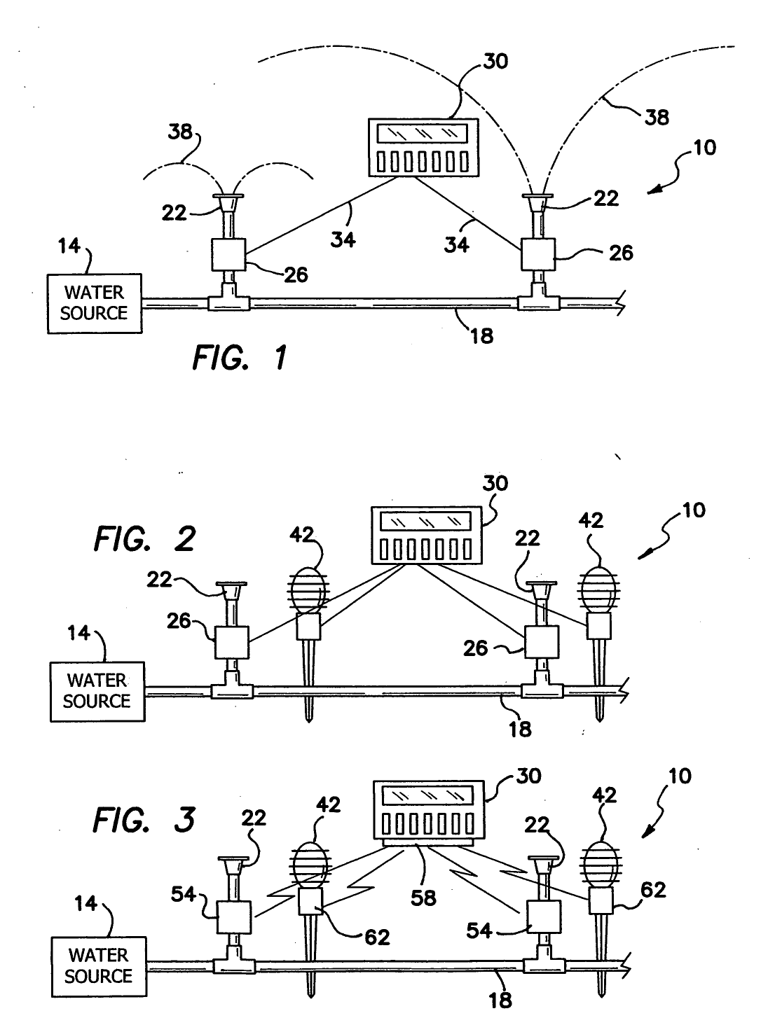

(1) FIGS. 1-4 illustrate an individually controlled sprinkler and lighting system 10 providing the desired features that may be constructed from the following components. A water source 14 is provided. The water source 14 provides water at a suitable pressure for a sprinkler system. A piping system 18 is provided. The piping system 18 is connected to the water source 14. At least two sprinkler heads 22 are provided. The sprinkler heads 22 are connected to the piping system 18 at locations remote from the water source 14. Each of the sprinkler heads 22 has an electrically controllable valving system 26. A microprocessor control system 30 is provided. The control system 30 is electrically connected to each of the sprinkler heads 22. The control system 30 is programmable and provides controllable input signals 34 to the sprinkler heads 22. When the control system 30 sends programmed control input signals 34 to the sprinkler heads 22, an individually adjusted flow 38 will be produced by each sprinkler head 22.

(2) In a variant of the invention, as illustrated in FIG. 2, at least two lighting fixtures 42 are provided. The lighting fixtures 42 are located adjacent the sprinkler heads 22. The lighting fixtures 42 are electrically connected to the microprocessor control system 30. When the control system 30 sends programmed control input signals 34 to the lighting fixtures 42, the fixtures 42 are individually controlled.

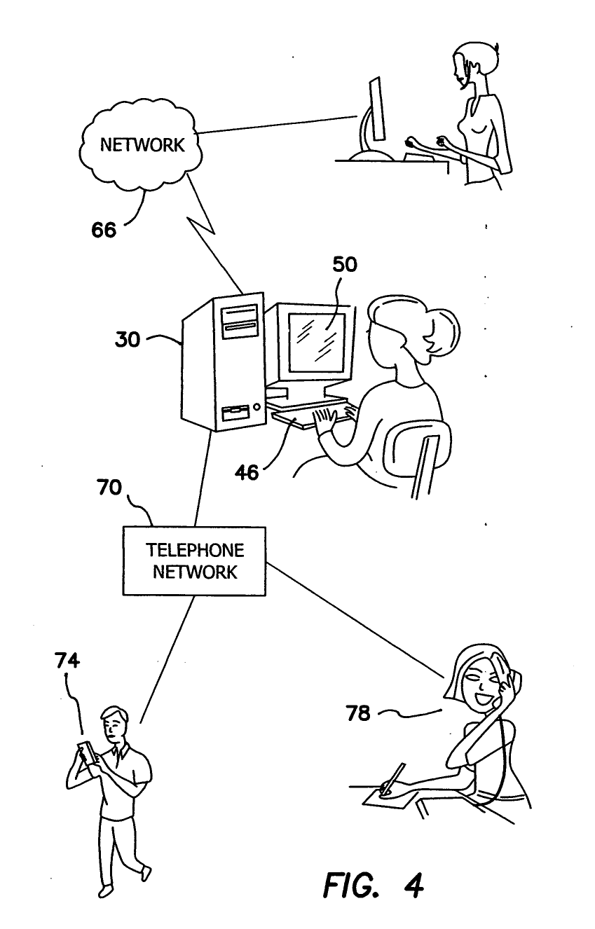

(3) In another variant, as illustrated in FIG. 4, the system 10 includes an input device 46 connected to the microprocessor control system 30.

(4) In still another variant, the system 10 includes a display screen 50 connected to the microprocessor control system 30.

(5) In yet another variant, as illustrated in FIG. 3, radio frequency controlled valving devices 54 are connected to each of the sprinkler heads 22 and a radio frequency signal generator 58 is connected to the microprocessor control system 30, thereby providing wireless control of the sprinkler heads 22.

(6) In a further variant, the system 10 includes radio frequency controlled input devices 62. The input devices 62 are electrically connected to the lighting fixtures 42 and a radio frequency signal generator 58 is connected to the microprocessor control system 30, thereby providing wireless control of the lighting fixtures 42.

(7) In still a further variant, as illustrated in FIG. 4, the microprocessor control system 30 is connected to a network 66. The network 66 is remotely accessed for programming and control of the control system 30.

(8) In yet a further variant, the microprocessor control system 30 is remotely accessed through a telephone network 70.

(9) In another variant of the invention, the microprocessor control system 30 is remotely accessed through a text-messaging system 74.

(10) In a final variant, the microprocessor control system 30 is remotely accessed through a voice recognition system 78.

An appreciation of the other aims and objectives of the present invention and an understanding of it may be achieved by referring to the accompanying drawings and the detailed description of a preferred embodiment.

The individually controlled sprinkler and lighting system 10 has been described with reference to particular embodiments. Other modifications and enhancements can be made without departing from the spirit and scope of the claims that follow.

1. An individually controlled sprinkler system, comprising:
a water source, said water source providing water at a suitable pressure for a sprinkler system;
a piping system, said piping system being connected to said water source;
at least two sprinkler heads, said sprinkler heads being connected to said piping system at locations remote from said water source;
each of said sprinkler heads having an electrically controllable valving system;
a microprocessor control system, said control system being electrically connected to each of said sprinkler heads;
said control system being programmable and providing controllable input signals to said sprinkler heads; and
whereby, when said control system sends programmed control input signals to said sprinkler heads, an individually adjusted flow will be produced by each sprinkler head.

2. The individually controlled sprinkler system as described in claim 1, further comprising:
at least two lighting fixtures, said lighting fixtures being disposed adjacent said sprinkler heads;
said lighting fixtures being electrically connected to said microprocessor control system; and
whereby, when said control system sends programmed control input signals to said lighting fixtures, the fixtures are individually controlled.

3. The individually controlled sprinkler system as described in claim 1, further comprising an input device connected to said microprocessor control system.

4. The individually controlled sprinkler system as described in claim 1, further comprising a display screen connected to said microprocessor control system.

5. The individually controlled sprinkler system as described in claim 1, further comprising radio frequency controlled valving devices connected to each of said sprinkler heads and a radio frequency signal generator connected to said microprocessor control system, thereby providing wireless control of said sprinkler heads.

6. The individually controlled sprinkler system as described in claim 1, further comprising radio frequency controlled input devices, said input devices electrically connected to said lighting fixtures and a radio frequency signal generator connected to said microprocessor control system, thereby providing wireless control of said lighting fixtures.

7. The individually controlled sprinkler system as described in claim 1, wherein said microprocessor control system is connected to a network, said network being remotely accessed for programming and control of said control system.

8. The individually controlled sprinkler system as described in claim 7, wherein said microprocessor control system is remotely accessed through a telephone network.

9. The individually controlled sprinkler system as described in claim 7, wherein said microprocessor control system is remotely accessed through a text-messaging system.

10. The individually controlled sprinkler system as described in claim 7, wherein said microprocessor control system is remotely accessed through a voice recognition system.
